(19) United States
(12) Patent Application Publication
(10) Pub. No.: US 2024/0300376 A1
(43) Pub. Date: Sep. 12, 2024

(54) MANAGEMENT APPARATUS

(71) Applicant: HONDA MOTOR CO., LTD., Tokyo (JP)

(72) Inventor: Hiroto Okabe, Tokyo (JP)

(21) Appl. No.: 18/582,698

(22) Filed: Feb. 21, 2024

(30) Foreign Application Priority Data
Mar. 10, 2023 (JP) 2023-037787

(51) Int. Cl. B60L 55/00; B60L 58/16

(52) U.S. Cl. CPC B60L 55/00; B60L 58/16

(57) ABSTRACT

A management apparatus includes: a use duration acquisition portion that acquires a use duration of a battery provided on a movable body; an index acquisition portion that acquires an index indicating a degradation state of the battery; an allowable reference value acquisition portion that acquires an allowable reference value which becomes a criterion of whether or not to allow a supply of electric power from the battery to an electric power trade market and is determined in accordance with the use duration of the battery; and a determination portion that determines a priority for determining whether or not to supply electric power to the electric power trade market in accordance with the use duration of the battery, the index, and the allowable reference value.

### CROSS-REFERENCE TO RELATED APPLICATION

Priority is claimed on Japanese Patent Application No. 2023-037787, filed on Mar. 10, 2023, the contents of which are incorporated herein by reference.

### BACKGROUND

### Field of the Invention

The present invention relates to a management apparatus.

### Background

In recent years, in order to ensure that more people have access to affordable, reliable, sustainable, and advanced energy, research and development relating to charging and electric power supply in a mobility on which a secondary battery is mounted, which contributes to energy efficiency, has been conducted.

In such a technical background, consumption electric energy of a rechargeable battery (hereinafter, also referred to as a “battery”) of a movable body (hereinafter, also referred to as a “vehicle”) by V2G depends on many factors such as how to use (for example, the way of driving, the way of charging, or the like) of a vehicle user, the frequency of connection of a plug, or the frequency of participation in the supply (hereinafter, also referred to as a DR (demand response) of electric power from the battery of the vehicle to the electric power trade market. Examples of the related art include a technique described in Japanese Unexamined Patent Application, First Publication No. 2013-109609.

### SUMMARY

Techniques relating to charging and electric power supply in a mobility on which a secondary battery is mounted include a technique relating to the DR as described above. The function of participating in the DR is an additional function of the vehicle. If a user continues to participate in the DR excessively, the battery is excessively used. This results in degradation of the battery to the extent of impairing actual usability of the vehicle, and accordingly, significant reduction in the price of a used car.

The present application aims to achieve a technique that prevents degradation of a battery. Further, the present application contributes to energy efficiency.

A management apparatus according to a first aspect of the present invention includes: a use duration acquisition portion that acquires a use duration of a battery provided on a movable body; an index acquisition portion that acquires an index indicating a degradation state of the battery; an allowable reference value acquisition portion that acquires an allowable reference value which becomes a criterion of whether or not to allow a supply of electric power from the battery to an electric power trade market and is determined in accordance with the use duration of the battery; and a determination portion that determines a priority for determining whether or not to supply electric power to the electric power trade market in accordance with the use duration of the battery, the index, and the allowable reference value.

A second aspect is the management apparatus according to the first aspect described above, wherein the priority may be determined in accordance with a difference between the index and the allowable reference value.

A third aspect is the management apparatus according to the first aspect described above which may further include: a guideline reference value acquisition portion that acquires a guideline reference value which is determined in accordance with the use duration of the battery and is determined as a guideline of the degradation state of the battery which supplies electric power to the electric power trade market, wherein the priority may be determined in accordance with a first value obtained by subtracting the allowable reference value from the index and a second value obtained by subtracting the allowable reference value from the guideline reference value.

A fourth aspect is the management apparatus according to the third aspect described above, wherein the priority may be a ratio of the first value to the second value.

According to the first to fourth aspects described above, it is possible to achieve a technique that prevents degradation of a battery.

### BRIEF DESCRIPTION OF THE DRAWINGS

FIG. 1 is a view showing a configuration example of a management system including a management apparatus according to an embodiment.

FIG. 2 is a functional block diagram representing a functional configuration of the management apparatus.

FIG. 3 is a view showing an example of a vehicle database.

FIG. 4 is a view showing an example of an allowable value database.

FIG. 5 is a view showing an example of a guideline value database.

FIG. 6 is a graph showing an example of an allowable reference value, a guideline reference value, and a SOH of a battery acquired from a vehicle.

FIG. 7 is a flowchart showing a process flow of the management apparatus.

### DESCRIPTION OF EMBODIMENTS

Hereinafter, a management apparatus according to an embodiment of the present invention will be described with reference to the drawings. The present embodiment is described using a vehicle as an example of a movable body.

FIG. 1 is a view showing a configuration example of a management system 1 including a management apparatus 100 according to the embodiment of the present invention. The management system 1 includes the management apparatus 100 and one or more vehicles 200_1 to 200_n (n is an integer of one or more). Hereinafter, when each of the vehicles 200_1 to 200_n is not particularly distinguished, any one may be represented as a vehicle 200.

A network 500 is constituted of a LAN (Local Area Network), a WAN (Wide Area Network), and a mobile phone line. The management apparatus 100 and the vehicle 200 can communicate with each other using the LAN or the WAN.

For a movable body (hereinafter, also referred to as a “vehicle”) having an electric storage device (hereinafter, also referred to as a “battery” or a “rechargeable battery”), the management apparatus 100 determines a priority for determining whether or not to supply electric power from the battery of the vehicle to an electric power trade market. In the following description, supplying of electric power from the battery of the vehicle to the electric power trade market is represented as a “DR”. In the present embodiment, a smaller priority corresponds to a less favorable situation for the battery and therefore indicates that degradation of the battery is promoted when participating in the DR. Accordingly, by using the priority determined by the management apparatus 100, it is possible to determine whether or not to participate in the DR.

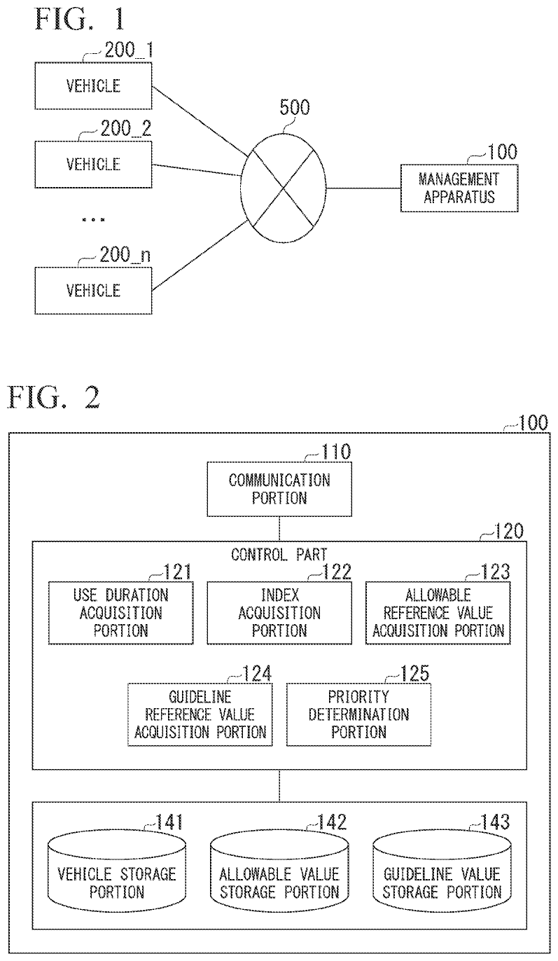

FIG. 2 is a functional block diagram representing a functional configuration of the management apparatus 100. The management apparatus 100 includes a CPU (Central Processing Unit), a memory, an auxiliary storage device, and the like that are connected by a bus. The management apparatus 100 executes a management program and thereby functions as an apparatus including a communication portion 110, a vehicle storage portion 141, an allowable value storage portion 142, a guideline value storage portion 143, and a control part 120. All or some of the functions of the communication portion 110, the vehicle storage portion 141, the allowable value storage portion 142, the guideline value storage portion 143, and the control part 120 may be implemented by using hardware such as an ASIC (Application Specified Integrated Circuit), a PLD (Programmable Logic Device), or a FPGA (Field Programmable Gate Array). The management program may be recorded on a computer-readable recording medium. The computer-readable recording medium is, for example, a portable medium such as a flexible disc, a magneto-optical disc, a ROM, or a CD-ROM or a storage device such as a hard disk contained in a computer system. The management program may be transmitted via a telecommunications line.

The communication portion 110 is a network interface. The communication portion 110 communicates with the vehicle 200 via the network 500.

The vehicle storage portion 141 stores a vehicle database. The allowable value storage portion 142 stores an allowable value database. The guideline value storage portion 143 stores a guideline value database.

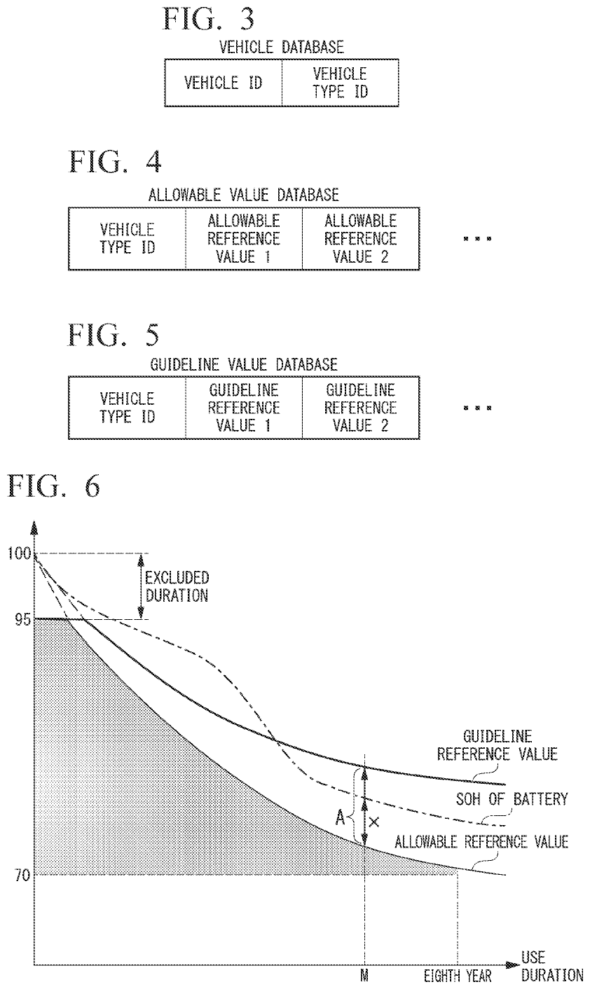

FIG. 3 is a view showing an example of a vehicle database. The vehicle database includes a vehicle ID and a vehicle type ID. The vehicle ID is an identifier for uniquely identifying a vehicle of a user. The vehicle type ID is an identifier for uniquely identifying a vehicle type. In the present embodiment, for ease of explanation, it is assumed that if the vehicle type ID is identical, an identical type of battery is mounted, and the battery has not been replaced. Therefore, when the vehicle ID can be acquired from the vehicle 200, the management apparatus 100 can identify the battery of the vehicle.

FIG. 4 is a view showing an example of an allowable value database. The allowable value database includes the vehicle type ID and a plurality of allowable reference values. The allowable reference value becomes a criterion of whether or not to allow a supply of electric power from the battery to the electric power trade market and is determined in accordance with a use duration of the battery. In the present embodiment, for example, the plurality of allowable reference values include an allowable reference value n (n is an integer of 1 to 120) for 10 years. The number n indicates a use duration on a monthly basis. That is, if n is 1, the use duration is 1 month, and the allowable reference value 1 indicates an allowable reference value at that time. If n is 65, the use duration is 5 years and 5 months, and the allowable reference value 65 indicates an allowable reference value at that time. The allowable reference value decreases monotonically in accordance with the increase of the use duration. Further, the allowable reference value is compared to an index indicating a degradation state acquired by the management apparatus 100 from the vehicle. As the index indicating a degradation state, in the present embodiment, a SOH (State of Health) of the battery is used.

FIG. 5 is a view showing an example of a guideline value database. The guideline value database includes the vehicle type ID and a plurality of guideline reference values. The guideline reference value is determined in accordance with the use duration of the battery and is determined as a guideline of the degradation state of the battery which supplies electric power to the electric power trade market. Specifically, in the present embodiment, a SOH of a battery of a vehicle of a user (a user who has a long travel distance or frequently participates in the DR) in which degradation of the battery is large is used. Further, in the present embodiment, for example, the plurality of guideline reference values include a guideline reference value n (n is an integer of 1 to 120) for 10 years. The number n indicates a use duration on a monthly basis. That is, if n is 1, the use duration is 1 month, and the guideline reference value 1 indicates a guideline reference value at that time. If n is 65, the use duration is 5 years and 5 months, and the guideline reference value 65 indicates a guideline reference value at that time. The guideline reference value decreases monotonically in accordance with the increase of the use duration. Further, the guideline reference value is indicated by the SOH, and if the use duration is identical, the guideline reference value is larger than the allowable reference value.

With reference back to FIG. 2, the control part 120 controls an operation of each portion of the management apparatus 100. The control part 120 is implemented, for example, by a device including a processor such as a CPU and a RAM. The control part 120 executes the management program and thereby functions as a use duration acquisition portion 121, an index acquisition portion 122, an allowable reference value acquisition portion 123, a guideline reference value acquisition portion 124, and a priority determination portion 125.

The use duration acquisition portion 121 acquires the use duration of the battery mounted on the vehicle 200 from the vehicle 200. The index acquisition portion 122 acquires an index indicating a degradation state of the battery from the vehicle 200. As described above, in the present embodiment, a SOH is used as the index. The allowable reference value acquisition portion 123 acquires an allowable reference value which becomes a criterion of whether or not to allow the supply of electric power from the battery to the electric power trade market and is determined in accordance with the use duration of the battery from the allowable value storage portion 142. The guideline reference value acquisition portion 124 acquires a guideline reference value which is determined in accordance with the use duration of the battery and is determined as a guideline of the degradation state of the battery which supplies electric power to the electric power trade market from the guideline value storage portion 143.

The priority determination portion 125 determines a priority for determining whether or not to supply electric power to the electric power trade market in accordance with the use duration of the battery, the SOH, and the allowable reference value. The determination method will be described later.

FIG. 6 is a graph showing an example of the allowable reference value, the guideline reference value, and the SOH of the battery acquired from the vehicle. In the graph shown in FIG. 6, the horizontal axis represents a use duration, and the vertical axis represents a SOH. As described above, the allowable reference value and the guideline reference value are set on a monthly basis and are therefore drawn discretely as it is in the graph. However, in FIG. 6, for example, by interpolation, the allowable reference value and the guideline reference value are continuous values. Further, in FIG. 6, a predetermined period from the zero year in which the use duration is short to the time when the SOH becomes about 95% is excluded from when the priority is determined; however, the embodiment is not limited thereto.

By using this graph, a determination method of the priority is described. The priority in the present embodiment is determined in accordance with a first value obtained by subtracting the allowable reference value from the SOH of the battery of the vehicle and a second value obtained by subtracting the allowable reference value from the guideline reference value. For example, in FIG. 6, for the priority at a timing when the use duration is M, the first value is x, and the second value is A. In the present embodiment, x/A which is the ratio of the first value x to the second value A is set as the priority.

As the SOH of the battery is larger than the allowable reference value, x becomes a larger value. On the other hand, when the SOH of the battery is smaller than the allowable reference value, x becomes a negative value. Further, x/A is proportional to x and becomes an upward-sloping graph since A is constantly positive.

The larger x/A indicates that the battery has a larger margin. The smaller x/A indicates that the state of the battery is less favorable. Accordingly, it is possible to determine whether or not to participate in the DR by using the priority.

By using not only x but also A, even when the use duration is different, it is possible to determine the degree of degradation. Specifically, as shown in FIG. 6, the difference between the guideline reference value and the allowable reference value is larger as the use duration is larger. Accordingly, the range where x is present tends to be narrower when the use duration is short, and the range where x is present tends to be wider when the use duration is long. Therefore, it is difficult to determine the degree of degradation in accordance with the use duration only by whether x is large or small. Accordingly, by using the ratio with A, even when the use duration is different, it is possible to relatively determine the degree of degradation.

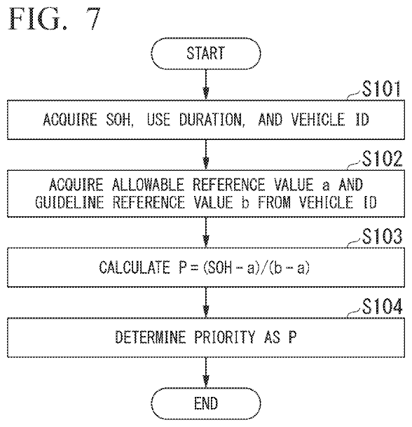

FIG. 7 is a flowchart showing a process flow of the management apparatus 100. In FIG. 7, the management apparatus 100 acquires the present SOH, the use duration, and the vehicle ID from the vehicle 200 (Step S101). The management apparatus 100 identifies the vehicle type ID from the vehicle ID by using the vehicle storage portion 141, the allowable value storage portion 142, and the guideline value storage portion 143 described above and acquires an allowable reference value a and a guideline reference value b from the vehicle type ID (Step S102).

The management apparatus 100 calculates P=(SOH−a)/(b−a) (Step S103), determines a priority P (Step S104), and completes the process. Here, SOH−a=x, and b−a=A. The determined priority is used for assigning a vehicle to participate in the DR. As described above, since the state of the battery is less favorable as the priority P is smaller, by assigning the vehicle to participate in the DR in the order of the larger priority P, it is possible to prevent degradation of the battery.

### Other Examples of Priority

In the embodiment described above, the priority P is x/A; however, it is enough to use x and A. For example, an inverse number A/x may be the priority P. In this case, a vehicle on which a battery having a low priority is mounted is preferentially assigned. A priority may be obtained by multiplying x/A or A/x by an appropriate coefficient. In this way, the priority may be determined in accordance with: the index indicating the degradation state; the allowable reference value which becomes the criterion of whether or not to allow the supply of electric power from the battery to the electric power trade market and is determined in accordance with the use duration of the battery; and the guideline reference value which is determined in accordance with the use duration of the battery and is determined as the guideline of the degradation state of the battery which supplies electric power to the electric power trade market.

Further, A may not be used, and only x may be the priority. As described above, x is 0 or more when the SOH is equal to or more than the allowable reference value, and x is negative when the SOH is less than the allowable reference value. Further, x becomes a larger value as the SOH is larger than the allowable reference value. Therefore, since even only x indicates at least that how much the difference from the allowable reference value is, by assigning the vehicle to participate in the DR in the order of larger x, it is possible to prevent degradation of the battery. The priority may be obtained by multiplying x by an appropriate coefficient. In this way, the priority may be determined in accordance with the index indicating the degradation state and the allowable reference value which becomes the criterion of whether or not to allow the supply of electric power from the battery to the electric power trade market and is determined in accordance with the use duration of the battery.

As described above, by determining the priority by using the index and the allowable reference value or determining the priority by using the index, the guideline value, and the allowable reference value, a vehicle to participate in the DR can be assigned in the order of the larger priority, and therefore, it is possible to prevent degradation of the battery.

In a related art, a use frequency and a use time for estimating the durability performance based on an experimental value are indirect criteria for the degree of degradation of the battery; however, actual degradation of the battery is greatly dependent on other factors, and a deviation may occur. Further, since each vehicle has a different production date and a different vehicle type, even when controlling a degradation rate by using an absolute criterion (a frequency, a time, or a degradation degree itself), it is difficult to determine the factor for determining the priority in uniformly controlling the degradation rate of the battery of each vehicle.

Further, in another related art, the degradation degrees of vehicles managed within a certain service are uniformed. This case is based on one-dimensional comparison using simply the degradation degree.

On the other hand, the present embodiment is based on two-dimensional comparison (two elements which are the SOH and the use duration) which is the depth of the degradation degree with respect to the use duration. Thereby, it is possible to determine the priority order between users having a different use start time or between users in different states of degradation degrees.

Further in the related art, for example, a vehicle having a battery which has a long use year and is accordingly degraded does not participate in the DR at all. On the other hand, in the present embodiment, even when the use duration is long, and the battery is degraded, it is possible to determine whether the degradation is excessive or there is a margin relatively. When there is a margin relatively, and the user participates in the DR, it is possible to continue to participate in the DR.

Although an embodiment of the present invention has been described, the present invention is not limited to such an embodiment, and various modifications and substitutions can be made without departing from the scope of the present invention.

What is claimed is:

1. A management apparatus comprising:
a use duration acquisition portion that acquires a use duration of a battery provided on a movable body;
an index acquisition portion that acquires an index indicating a degradation state of the battery;
an allowable reference value acquisition portion that acquires an allowable reference value which becomes a criterion of whether or not to allow a supply of electric power from the battery to an electric power trade market and is determined in accordance with the use duration of the battery; and
a determination portion that determines a priority for determining whether or not to supply electric power to the electric power trade market in accordance with the use duration of the battery, the index, and the allowable reference value.

2. The management apparatus according to claim 1,
wherein the priority is determined in accordance with a difference between the index and the allowable reference value.

3. The management apparatus according to claim 1, further comprising:
a guideline reference value acquisition portion that acquires a guideline reference value which is determined in accordance with the use duration of the battery and is determined as a guideline of the degradation state of the battery which supplies electric power to the electric power trade market,
wherein the priority is determined in accordance with a first value obtained by subtracting the allowable reference value from the index and a second value obtained by subtracting the allowable reference value from the guideline reference value.

4. The management apparatus according to claim 3,
wherein the priority is a ratio of the first value to the second value.
